(19) United States
(12) Patent Application Publication
(10) Pub. No.: US 2025/0278934 A1
(43) Pub. Date: Sep. 4, 2025

(54) INTEGRATED MANAGEMENT SYSTEM OF SMART FARM USING MUTI-HOP NETWORK

(71) Applicant: MIDBAR CO., LTD., Pohang-si (KR)

(72) Inventors: Min Ho KIM, Hanam-si (KR); Hae Young PARK, Anyang-si (KR); Gyu Seung CHOI, Pohang-si (KR); Jun Hui KIM, Mungyeong-si (KR)

(21) Appl. No.: 18/008,727

(22) PCT Filed: Dec. 5, 2022
(86) PCT No.: PCT/KR2022/019553

§ 371 Date: Jan. 26, 2023

(30) Foreign Application Priority Data
Nov. 29, 2022 (KR) 1020220162475

(51) Int. Cl. G06V 20/10; G06V 10/75; G06V 10/764; G06V 20/17; G08C 17/00; H04N 7/18

(52) U.S. Cl. CPC G06V 20/188; G06V 10/751; G06V 10/764; G06V 20/17; G08C 17/00; H04N 7/183

(57) ABSTRACT

The present invention relates to an integrated management system of a smart farm using a multi-hop network, and more specifically, to an integrated management system of a smart farm in which a sensor node and a control node for a growth environment of cultivated crops are installed inside a house of a smart farm, and a multi-hop network where the sensor nodes and the control nodes of a plurality of houses adjacent to each other are connected to one gateway together with a drone node is constructed, and a management server connected to the gateway evaluates a development status of the cultivated crops to provide an optimal growth environment.

### TECHNICAL FIELD

The present invention relates to an integrated management system of a smart farm using a multi-hop network, and more specifically, to an integrated management system of a smart farm in which a sensor node and a control node for a growth environment of cultivated crops are installed inside a house of a smart farm, and a multi-hop network where the sensor nodes and the control nodes of a plurality of houses adjacent to each other are connected to one gateway together with a drone node is constructed, and a management server connected to the gateway evaluates a development status of the cultivated crops to provide an optimal growth environment.

### BACKGROUND ART

Agriculture, which produces food essential for the survival of human beings, is strongly influenced by the natural environment, such as soil and climate, so it is not easy to promote technological innovation in agriculture compared to other industries. Despite such limitations, so-called smart farm technology that enhances production and management efficiency by integrating cutting-edge technologies, such as the latest Internet of Things (IoT), big data, drones or the like, with the production and consumption processes of various agricultural products is attracting attention.

For example, Korean Registered Patent No. 10-1726257 (Apr. 6, 2017) discloses a smart farm information management system that provides product sales information that changes according to the growth information of crops to be managed, and Korean Registered Patent No. 10-2331141 (Nov. 22, 2021) discloses an improved smart farm management system that provides an optimal operation method according to the characteristics of cultivated crops, an installation location, climate, and the like using machine learning technology.

In addition, Korean Registered Patent No. 10-2334681 (Nov. 30, 2021) discloses a smart farm control device that provides an optimal growth environment by referring to a remote reference farm in which the same crops are sown, and Korean Registered Patent No. 10-2371909 (Mar. 3, 2022) discloses a smart farm crop monitoring system that monitors the growth and diseases and pests of crops using a drone.

### RELATED ART DOCUMENTS

### Patent Documents

Korean Registered Patent No. 10-1726257 (Apr. 6, 2017)

Korean Registered Patent No. 10-2331141 (Nov. 22, 2021)

Korean Registered Patent No. 10-2334681 (Nov. 30, 2021)

Korean Registered Patent No. 10-2371909 (Mar. 3, 2022)

### DISCLOSURE

### Technical Problem

In general, a smart farm has a structure in which a sensor unit and a control device are installed inside a house in which crops are cultivated, and the sensor unit and control device are connected to a management server through a gateway. However, in the conventional smart farm, each house needs to have a separate gateway that connects the sensor unit and the control unit to the management server.

Therefore, in the case of a smart farm composed of a plurality of houses, it is difficult to construct a system for managing the growth environment of each of the houses in an integrated manner, and in particular, when additionally installing a new house to a previously operating smart farm house or managing a remote house that is geographically several kilometers or more away from a previously installed gateway, it is difficult to expand a communication network capable of managing the houses in an integrated manner.

Therefore, it is an object of the present invention to provide an integrated management system of a smart farm capable of, in a smart farm composed of a plurality of houses, efficiently managing growth environments of each of the houses in an integrated manner and in particular, very easily expanding a communication network even for an additionally installed house or a geographically remote house.

In addition, it is another object of the present invention to provide an integrated management system of a smart farm capable of providing an optimal growth environment for each type of cultivated crop using artificial intelligence (AI), or leveling up the growth level of cultivated crops, thereby improving the productivity of crops.

### Technical Solution

One aspect of the present invention provides an integrated management system of a smart farm using a multi-hop network, the integrated management system characterized by including: a sensor node (10) configured to measure a growth environment of crops cultivated inside a house (H) of a smart farm and generate environment data; a control node (20) configured to control the growth environment; a drone node (30) configured to photograph a development status of the crops to generate a development image; a gateway (40) configured to connect the sensor node (10), the control node (20), and the drone node (30) to an Internet communication network; a management server (50) configured to receive the environment data and the development image of each house (H) through the gateway (40) and classify the environment data and the development image and store the classified environment data and the classified development image and issue a control command for the control node (20); and a user terminal (60) configured to allow the environment data and the development image from the management server 50 to be browsed and the control command to be input,

The sensor node (10) and the control node (20) may be characterized by constituting a multi-hop network in which sensor nodes (10) and control nodes (20) of a plurality of neighboring houses (H) may serve as routers using the gateway (40) as a destination node.

In addition, the drone node (30) may be characterized by serving as a mobile relay node that may connect the sensor node (10) and the control node (20) to each other or connect the sensor node (10) and the control node (20) to the gateway (40) while flying inside the house (H) or between the houses (H).

In addition, the drone node (30) may be characterized by being additionally equipped with an environment sensor configured to measure a growth environment of crops cultivated inside the house (H) and calculate environment data.

In addition, the drone node (30) may be characterized by, with the environment data generated by the sensor node (10) being wirelessly downloaded and received or with the environment data or development image generated by itself being stored therein, flying a predetermined distance and transmitting the environment data or the development image to the gateway (40), and with a control command being wirelessly downloaded from the management server (50) and received, flying a predetermined distance and transmitting the control command to the gateway (40).

The management server (50) may be characterized by comparing and analyzing the development images provided from the drone node (30) to evaluate the development status of crops cultivated in each of the houses H, and issuing, through the gateway (40), the control command for the control node (20) to provide an optimal growth environment for the cultivated crops.

### Advantageous Effects

In an integrated management system of a smart farm according to the present invention, a plurality of houses are connected via one multi-hop network, and thus integrated management of the smart farm can be facilitated, and when a new house is added, a sensor node and a control node of the new house can be easily connected to the multi-hop network and furthermore, by using a drone node, communication can be extended to a remote house that is geographically distant or a house in an area in which the Internet is not connected.

In addition, in an integrated management system of a smart farm according to the present invention, a management server can derive the optimal growth environment for crops in each house using artificial intelligence (AI), or level up the growth level of crops in a plurality of houses using an excellent house, thereby improving the productivity of crops.

### DESCRIPTION OF DRAWINGS

FIG. 1 is a conceptual diagram illustrating a configuration of an integrated management system of a smart farm according to the present invention.

### MODES OF THE INVENTION

Hereinafter, the present invention will be described in detail with reference to the accompanying drawings. However, detailed descriptions of configurations that are introduced in the related art or that can be easily implemented by a person skilled in the art from the known technology will be omitted even if the configurations are essential for practicing the present invention. In addition, the term “unit” or “means” of elements belonging to the present invention refers to a unit of processing one or more functions or operations, and is implemented as hardware or software or a combination of hardware and software.

In addition, key terms used to describe the present invention have specially defined meanings according to the purpose of the present invention. In the present invention, “a house H” is a facility having an independent cultivation space to provide a controllable growth environment under conditions separated from natural conditions, such as a glass greenhouse, a vinyl house, or a container farm. In addition, “a smart farm” refers to a farm in which a plurality of separated “houses H” are connected to a server through a single gateway and managed and operated according to a single communication network.

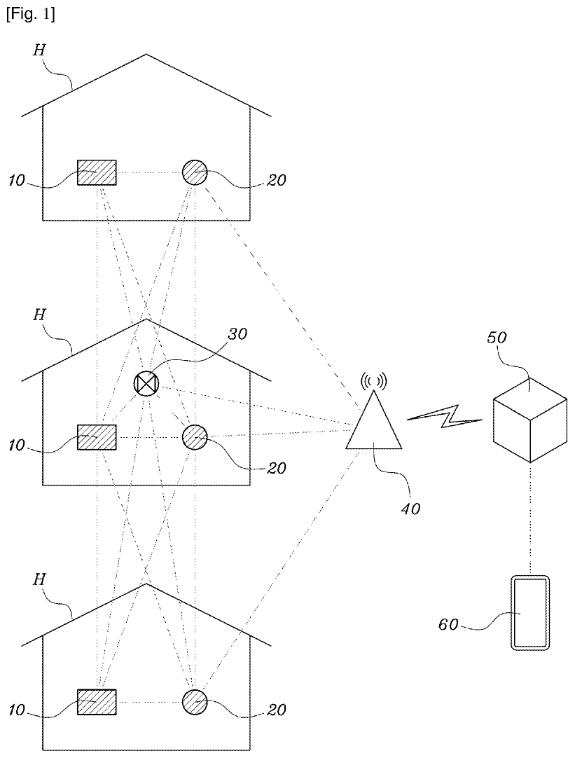

As shown in FIG. 1, a management system of a smart farm according to the present invention includes a sensor node 10 and a control node 20 installed inside each house H of a smart farm, a drone node 30 flying inside or outside the house H, a gateway 40 connecting the nodes 10, 20, and 30 to an Internet communication network, a management server 50 connected to the gateway 40 in a wired or wireless manner, and a user terminal 60. In FIG. 1, for the sake of convenience of description, a case in which three houses H are provided is illustrated, but the number of houses H may be continuously expanded as needed.

The sensor node 10 serves to measure a growth environment of cultivated crops inside the house H of the smart farm and generate various types of environment data according to a result of the measurement. The environment data may include all factors that affect the growth of cultivated crops, such as a temperature, a humidity, and an amount of sunlight inside the house H, a humidity of culture soil, a concentration of CO₂, a concentration of a culture solution, a spray cycle of a culture solution, a temperature of a root zone of crops, and the like. To this end, a plurality of environment sensors for measuring the environment data may be connected to the sensor node 10 in a wired or wireless manner. The sensor node 10 may be installed as a single unit or a plurality of units in each of the houses H.

The control node 20 serves to control the growth environment in each of the houses H. To this end, control devices for controlling the growth environment may be connected to the control node 20 in a wired or wireless manner. The control device may include a heater, an air conditioner, a light emitting diode (LED) light, a humidity controller, a culture solution injector, a CO₂ generating unit, and the like. The control node 20 may be installed as a single unit or a plurality of units in each of the houses H as needed.

The drone node 30 first photographs a development status of the crops cultivated inside the house H to generate a development image. The development image refers to an image for identifying the density of crops or fruits thereof per unit area, the size of crops or fruits thereof, the color of crops or fruits thereof, and the like. The drone node 30 may employ a drone specially manufactured for the present invention, or a drone combining a general agricultural drone with a camera and a communication device capable of achieving the object of the present invention. The drone node 30 may be provided as one drone jointly used by several houses H.

The gateway 40 serves to connect the sensor nodes 10, the control nodes 20, and the drone nodes 30 to the Internet communication network. The gateway 40 may be installed in an appropriate place to communicate with a plurality of houses H inside the smart farm, and may be provided using a conventional gateway.

The management server 50 receives the environment data and the development images of each of the houses H through the gateway 40 and classifies and stores the received environment data and the development images by house, by crop, and by date. In addition, the management server 50 issues a control command for the control devices connected to the control node 20 to adjust the growth environment inside the house H. The management server 50 may be connected to the gateway 40 through a common Internet.

The user terminal 60 may allow the environment data and the development images stored in the management server 50 to be browsed and display the environment data and the development images to the user by house, by crop, and by date. The user may check the development statuses and the growth environment of the crops cultivated in each of the houses H in real time through his or her user terminal 60. In addition, the user may input a control command for the control node 20 into the management server 50 using the user terminal 60. As the user terminal 60, a smart phone or a personal computer (PC) may be used.

According to the present invention, the sensor node 10 and the control node 20 constitute an integrated network in which the sensor node 10 and the control node 20 are connected to each other via multi-hop routing using one gateway 40 as a destination node. That is, not only the sensor node 10 and the control node 20 installed in the same house H but also the nodes 10 and 20 disposed in neighboring houses H serve as routers and transmit a packet provided by a starting node to a destination node. It is preferred that the multi-hop network has a mesh topology.

Specifically, when one of the sensor nodes 10 cannot directly transmit environment data generated by itself to the gateway 40, the sensor node 10 may set a destination node of a packet including the environment data as the gateway 40 and transmit the packet to one, which is in the best communication state, of neighboring sensor nodes 10 and neighboring control nodes 20 that can receive the packet. In this case, the sensor node 10 that has generated the environment data becomes a starting node, and the node receiving the packet from the starting node becomes a primary relay node.

The primary relay node confirms that the destination node of the corresponding packet is not itself, and transmits the packet to a node with the best communication state among the sensor nodes 10 and the control nodes 20 capable of transmitting the packet. In this manner, a node that has received the packet from the primary relay node becomes a secondary relay node. Such routing relay is repeated until the packet from the starting node is transmitted to the gateway 40, which is the destination node.

A control command issued from the management server 50 to the control node 20 is also transmitted in this multi-hop routing method. However, in this case, the gateway 40 becomes a starting node, and the control node 20 to receive the control command becomes a destination node. In such a multi-hop network, when some of the sensor nodes 10 or the control nodes 20 are disabled for communication due to failure or power exhaustion, the packet is provided to bypass the disabled nodes and select another relay node enabled for communication as a router. Therefore, packets are transmitted along the most efficient routing path from the starting node to the destination node.

According to an exemplary embodiment of the present invention, the sensor node 10 may include: a data collection unit configured to manage an environment sensor connected to the sensor node 10 and collect environment data from the environment sensor; a packet generating unit configured to convert the environment data into a digital signal to generate a packet; a destination node setting unit configured to set a destination node of the packet as the gateway 40; a packet receiving unit configured to receive packets from other neighboring nodes; a router selecting unit configured to determine a router to which the packets are transmitted; a packet transmitting unit configured to transmit the packet to the router; and the like.

In addition, the control node 20 may include: a control command reception unit configured to receive a control command issued from the management server 50; a control device managing unit configured to control the control devices connected to the control node 20 according to the control command; a packet receiving unit configured to receive a packet from other neighboring nodes; a router selecting unit configured to determine a router to which the packets are transmitted; a packet transmitting unit configured to transmit the packet to the router; and the like.

On the other hand, the drone node 30 may serve as a mobile relay node that, while flying inside the house H or between the houses H, connects the sensor node 10 and the control node 20 to each other or connects the sensor node 10 and the control node 20 to the gateway 40. That is, the drone node 30 may become a starting node that transmits a development image generated by itself, or may become a relay node that receives a packet from other starting nodes or relay nodes and transmits the packet to other nodes or the gateway. As described above, the drone node 30 may be used as a mobile relay node, and even in areas in which a communication fault occurs due to a failure or power exhaustion of the sensor node 10 or the control node 20, or in which a communication fault occurs because houses H are too far away from each other, a smooth multi-hop network may be constructed using the drone node 30 as a router.

The drone node 30 may include: a frame unit on which drone wings are installed; a distance detecting sensor configured to detect a distance to crops during flight and avoid a collision with an object ahead; a camera unit configured to photograph a development status of cultivated crops; a packet generating unit configured to convert the image photographed by the camera unit into a digital signal to generate a packet including a development image; a destination node setting unit configured to set a destination node for the packet as the gateway 40; a packet receiving unit configured to receive a packet from neighboring other nodes; a router selecting unit configured to determine a router to which the packets are transmitted; a packet transmitting unit configured to transmit the packet to the router; and the like.

In addition, the drone node 30 may additionally be equipped with an environment sensor configured to measure a growth environment of crops cultivated inside the house H and calculate environment data. The environment sensor mounted on the drone node 30 may be one or more of a temperature sensor, an illuminance sensor, and a CO₂ sensor. As described above, when the environment sensor may be mounted on the drone node 30, and even in areas in which the sensor node 10 is not installed or in areas in which malfunction occurs due to a failure or power exhaustion of the sensor node 10, the growth environment may be measured using the environment sensor mounted on the drone node 30.

In addition, the drone node 30 may, with the environment data generated by the sensor node 10 being downloaded wirelessly or with the environment data or development image generated by itself being stored therein, fly a predetermined distance and transmit the environment data or the development image to the gateway 40. In addition, the drone node 30 may, with a control command for the control node 20 being wirelessly downloaded from the management server 50 and received, fly a predetermined distance and transmit the control command to the gateway 40. Use of the function of the drone node 30 may allow the integrated management system according to the present invention to be expanded even to a remote house H that is several kilometers or more away from the gateway 40 according to the present invention, or a house H located in an area in which the Internet is not connected.

The management server 50 compares and analyzes the development images provided from the drone node 30 to evaluate the development status of the crops cultivated in each of the houses H, and in particular, issues, through the gateway 40, a control command for a house H, in which the development status of crops is sluggish, such that the control node 20 provides the optimal growth environment.

Specifically, the management server 50 may include: a data storage unit configured to classify and store the environment data provided from the sensor nodes 10 and the development images provided from the drone node 30 by house, by crop, and by date; a development status evaluation unit configured to compare the development images stored in the data storage unit to evaluate the development status of the crops cultivated in each of the houses H; a growth environment derivation unit configured to compare the environment data and the development image, which are stored in the data storage unit, with each other to derive an optimal growth environment for each cultivated crop; and a control command transmitting unit configured to issue a control command for a house (H), in which the development status of the crops is sluggish as a result of the evaluation of the development status evaluation unit, such that the control node 20 provides the optimal growth environment according to a result derived by the growth environment derivation unit.

According to an exemplary embodiment of the present invention, the management server 50 may use artificial intelligence (AI) to evaluate the development status of crops cultivated in each of the houses H, and also use AI to derive the optimal growth environment for the crops. That is, AI may be loaded in the management server 50, and the AI may perform analysis by comparing the environment data and the development images, which are stored in the management server 50, with each other, thereby learning the correlation between an average development status in a sowing time for each type of cultivated crops and a growth environment according to machine learning or deep learning techniques. In addition, based on the learning results, the management server 50 may evaluate the development status of the crops cultivated in each of the houses H and derive the optimal growth environment for the cultivated crops.

In addition, according to another embodiment of the present invention, the management server 50 may compare the development images provided from the drone node 30 with each other to select an excellent house with the best development status of crops, and issue a control command for a house H with a sluggish development status of crops to maintain the same growth environment as that of the excellent house. However, it is preferable that the present embodiment is applied to houses H having the same type of cultivated crops, and the development statuses of crops cultivated in a plurality of Houses H may be leveled up.

In another embodiment according to the present invention, the user may compare and analyze the development images provided from the drone node 30 based on his or her knowledge and experience to evaluate the development status of cultivated crops, and input, through the user terminal 60, a control command for a house H, in which the development status of crops is sluggish, such that the control node 20 provides the optimal growth environment.

As described above, the integrated management system of the smart farm according to the present invention exemplified a case in which one smart farm uses one gateway 40. However, when the gateways 40 of several smart farms that are separated from each other are connected to one server using an Internet communication network and a cloud server, it is possible to construct a regionally, nationally, and even internationally expanded smart farm network. By using the smart farm network, it is possible to accumulate vast amounts of data on various types of crops from a plurality of smart farms operated by different farmers in different regions, and such data may become a common asset for mankind to innovatively develop agricultural technology.

### DESCRIPTION OF REFERENCE NUMERALS

| | |
|---|---|
| (10) sensor node | (20) control node |
| (30) drone node | (40) gateway |
| (50) management server | (60) user terminal |
| (H) house of smart farm | |

1. An integrated management system of a smart farm using a multi-hop network, the integrated management system comprising:
a sensor node (10) configured to measure a growth environment of crops cultivated inside a house (H) of a smart farm and generate environment data;
a control node (20) configured to control the growth environment;
a drone node (30) configured to photograph a development status of the crops to generate a development image;
a gateway (40) configured to connect the sensor node (10), the control node (20), and the drone node (30) to an Internet communication network;
a management server (50) configured to receive the environment data and the development image of each house (H) through the gateway (40) and classify the environment data and the development image and store the classified environment data and the classified development image and issue a control command for the control node (20); and
a user terminal (60) configured to allow the environment data and the development image from the management server 50 to be browsed and the control command to be input,
wherein the sensor node (10) and the control node (20) constitute a multi-hop network in which sensor nodes (10) and control nodes (20) of a plurality of neighboring houses (H) serve as routers using the gateway (40) as a destination node;
the drone node (30) serves as a mobile relay node that connects the sensor node (10) and the control node (20) to each other or connects the sensor node (10) and the control node (20) to the gateway (40) while flying inside the house (H) or between the houses (H); and
the management server (50) is configured to compare and analyze the development images provided from the drone node (30) to evaluate the development status of crops cultivated in each of the houses H, and issue, through the gateway (40), the control command for the control node (20) to provide an optimal growth environment for the cultivated crops.

2. The integrated management system of claim 1, wherein the sensor node (10) includes:
a data collection unit configured to collect the environment data from an environment sensor connected thereto;
a packet generating unit configured to convert the environment data into a digital signal to generate a packet;
a destination node setting unit configured to set a destination node of the packet as the gateway (40);
a packet receiving unit configured to receive packets from other neighboring nodes;
a router selecting unit configured to determine a router to which the packets are transmitted; and
a packet transmitting unit configured to transmit the packet to the router.

3. The integrated management system of claim 1, wherein the drone node (30) is equipped with an environment sensor configured to measure a growth environment of crops cultivated inside the house (H) and calculate environment data.

4. The integrated management system of claim 1, wherein the drone node (30) is configured to, with the environment data generated by the sensor node (10) being wirelessly downloaded and received or the development image generated by itself being stored therein, fly a predetermined distance and transmit the environment data or the development image to the gateway (40), and is configured to, with the control command being wirelessly downloaded from the management server (50) and received, fly a predetermined distance and transmit the control command to the gateway (40).

5. The integrated management system of claim 1, wherein the management server (50) includes:
a data storage unit configured to classify the environment data provided from the sensor nodes (10) and the development images provided from the drone node (30) by house, by crop, and by date;
a development status evaluation unit configured to compare the development images stored in the data storage unit to evaluate the development status of the crops cultivated in each of the houses (H);
a growth environment derivation unit configured to compare the environment data and the development image, which are stored in the data storage unit, with each other to derive an optimal growth environment for each cultivated crop; and
a control command transmitting unit configured to issue a control command for a house (H), in which the development status of the crops is sluggish as a result of the evaluation of the development status evaluation unit, such that the control node 20 provides the optimal growth environment according to a result derived by the growth environment derivation unit.

6. The integrated management system of claim 1, wherein the management server (50) evaluates the development status of the crops grown in each of the houses (H) using artificial intelligence (AI) and derives the optimal growth environment for the crops using AI.

7. The integrated management system of claim 1, wherein the management server (50) compares the development images provided by the drone node (30) with each other to select an excellent house in which a development status of crops is best, and issue a control command for a house (H), in which a development status of crops is relatively sluggish, to maintain the same growth environment as the excellent house.
